(19) United States
(12) Patent Application Publication
(10) Pub. No.: US 2007/0219905 A1
(43) Pub. Date: Sep. 20, 2007

(54) PAYMENT AUTHORIZATION SYSTEM FOR FINANCIAL TRANSACTIONS USING A MESH-CAPABLE DEVICE

(76) Inventors: Charles Steven Gohmann, Indianapolis, IN (US); Larry D. O'Cull, Westfield, IN (US); Gary Joel Meyer, Indianapolis, IN (US)

Correspondence Address: BARNES & THORNBURG LLP, 11 SOUTH MERIDIAN, INDIANAPOLIS, IN, 46204, US

(21) Appl. No.: 11/613,520

(22) Filed: Dec. 20, 2006

Related U.S. Application Data
(60) Provisional application No. 60/752,499, filed on Dec. 21, 2005.

(51) Int. Cl. G06Q 40/00

(52) U.S. Cl. 705/44

(57) ABSTRACT

A remotely programmable system for authorizing customer purchases includes a portable unit having a method for obtaining the customer's information, a method for entering the purchase amount and customer's signature, a mesh-capable wireless transceiver for securely transmitting the customer's information to a mesh-capable host device, where said mesh-capable host device can then securely transmit the customer's information over a wide area network (WAN) to a transaction processor. The transaction processor verifies the customer's information, the amount of the purchase, and other applicable information with a third-party processor or financial institution that then transmits an authorization code back to the transaction processor. The authorization code is transmitted back to the portable unit through the mesh-capable host device. Once the portable unit receives the authorization code, the customer is prompted to provide the customer's final approval by signature on a touch screen, signature pad, or the like. Once the customer's final approval is obtained, the customer's information, the purchase amount, the authorization code, and the customer's signature are transmitted back to the transaction processor through the mesh-capable host device.

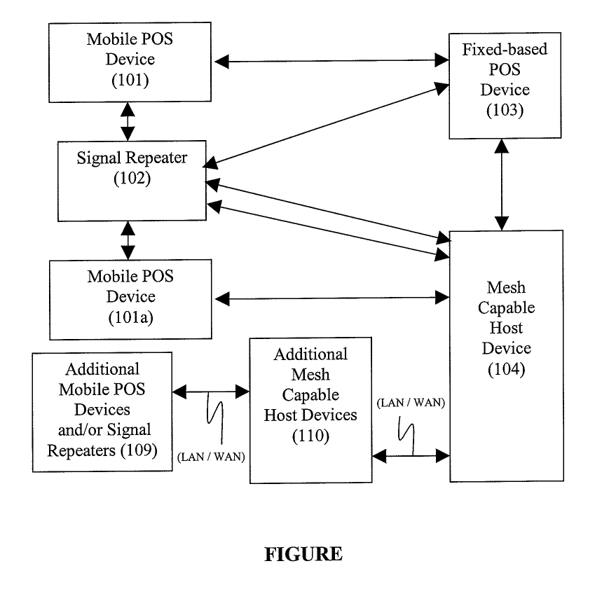

### CROSS-REFERENCE TO RELATED APPLICATIONS

This application claims the benefit under 35 U. S. C. § 119(e) of the filing date of U.S. Ser. No. 60/752,499 filed Dec. 21, 2005, the complete disclosure of which is hereby incorporated herein by reference.

### BACKGROUND OF THE INVENTION

1. Technical Field

The present invention relates generally to the use of mesh-capable devices for authorizing payment of financial transactions where a remotely programmable, portable device transmits the customer's (hereinafter sometimes cardholder's) information, purchase amount, and cardholder's final approval signature for a financial transaction through a mesh-capable host device to a transaction processor connected to a Wide Area Network (hereinafter sometimes WAN or Internet) where approval for the transaction is received from the appropriate third-party processor or financial institution. The invention is particularly useful in authorizing credit card purchases in an environment where telephone or other fixed hardwire systems are uneconomical, undesirable or otherwise unavailable.

2. Description of Related Art

The use of electronic transactions such as credit card and debit card transactions has become more commonplace because of their widespread acceptance and ease of use to both the consumer and merchant for the purchase of goods and services. Security enhancements to both the cards themselves (e. g., smartcards, biometrics) and to the method of information transfer (e. g., data encryption) have contributed to this widespread acceptance.

Recent technology enhancements to mobile telephones, personal digital assistants (hereinafter sometimes PDAs) such as the popular Blackberry PDAs, and other personal electronic devices have also increased the popularity for using these devices for initiating financial transactions. However, even with the technological enhancements, these devices are primarily developed and used for voice communications and organizing information such as schedules, contact lists, and more recently sending and receiving text messages and e-mails.

As future enhancements to both the traditional credit/debit cards and customer-owned electronic devices are realized and deployed for use in initiating and completing financial transactions, the existing and still growing use of traditional credit/debit cards will continue to cause customers to demand merchants employ methods to accept card-based forms of payment in more locations, especially if the “point-of-sale” is not in a physical location (e. g., store).

Below are some common wireless methods of completing financial transactions between customers and merchants.

Wireless/Fixed-based Point-of Sale Systems:

This type of system is effectively a wireless “extension” of a fixed-based station (e. g., cash register). A merchant's employee provides a merchant-owed or merchant-leased portable wireless device (essentially a card reader) that enables a cardholder to transmit the cardholder's card's information from any location in the merchant's store to the fixed-based station. The fixed-based station may be connected by a regular phone line, cable/DSL modem, or wireless link to a third-party processor or financial institution that processes the transaction. Regardless of the wireless technology linking the portable device and the fixed-based station, these systems are usually “peer-to-peer” (i. e., the portable wireless device and the fixed-based station are a “matched set”) and are essentially only compatible with each other for use within the merchant's facility.

Financial Transactions Using a Single or Dual Chip

Mobile Device Such as Mobile Phone or PDA

A consumer may also conduct a financial transaction by wirelessly connecting to a WAN (e. g., Internet) through a mobile phone or a PDA. Once connected, this method of conducting financial transactions does not substantially differ from conducting any other financial transaction from a desktop or laptop personal computer through a web-browser that accesses the Internet. Customer-owned electronic devices used for this purpose include various combinations of embedded or plug-in chipsets that employ Wireless Application Protocol (hereinafter sometimes WAP), Subscriber Identity Module (hereinafter sometimes SIM), or Wireless Identity Module (hereinafter sometimes WIM) technologies. More recently, mobile phones and PDAs have been equipped with a chipset and “slot” for reading the magnetic strips on credit/debit cards, and once the cardholder's information is obtained, the cardholder's (and merchant's) information is wirelessly transmitted to a third-party processor or financial institution for authorization.

Bluetooth and Other Personal Area Networks (Hereinafter Sometimes PANs)

A Bluetooth-enabled system allows for the exchange of information between devices like personal digital assistants (PDAs), mobile phones, desktop or laptop computers, or other compatible devices over secure, low-cost, globally available short range, wireless radio frequencies. In the case of financial transactions, the consumer's Bluetooth-enabled device creates a PAN between the consumer's Bluetooth-enabled device and the merchant's Bluetooth-enabled device utilizing Bluetooth protocol. The merchant's device may be a fixed-based cash register, wireless terminal, or computer server. The merchant's device is usually connected to a third-party processor or financial institution over a WAN such as the Internet. These Bluetooth protocol based systems, although gaining in popularity and acceptance still have the same inherent drawbacks as other financial transaction systems that are based upon a customer's wireless mobile devices, the primary drawbacks being that the customer must possess a device, and that the customer's device must be compatible with the merchant's device for financial transactions to be conducted.

The present invention provides a more efficient method of completing financial transactions when credit cards or debit cards are used in traditional, fixed locations such as stores or restaurants and in more non-traditional (and perhaps non-fixed locations) such as outdoor festivals, fairs and other events where traditional card systems are impractical and purchases may be large, but tend to be relatively small. Further, the present system does not require the customer (cardholder) to possess an electronic device such as a mobile telephone or PDA.

### DISCLOSURE OF THE INVENTION

A method for completing a financial transaction between a customer and a merchant of goods or services comprises inputting personal customer information and specific merchant information into a portable unit and wirelessly transmitting the customer's personal information and specific merchant information from said portable unit. The method further includes wirelessly receiving the customer's personal information and specific merchant information from the portable unit at a host device. After acquiring the customer's personal information and specific merchant information from the portable unit, the customer's personal information and specific merchant information are transmitted from the host device to a transaction processor for verification and authorization of the customer's personal information and specific merchant information. After verification and authorization of the customer's personal information and specific merchant information is received by the transaction processor, the verification and authorization from the transaction processor are transmitted back to the portable device through the host device for completion of the financial transaction.

Illustratively, inputting a customer's personal information and specific merchant information into a portable unit and wirelessly transmitting the customer's personal information and specific merchant information from said portable unit includes using at least one of a magnetic strip reader, a radio frequency identification (RFID) reader, a touch-screen, a digitizing signature pad, a barcode reader, and a biometric sensor for acquiring at least one of the customer's personal information and the specific merchant information.

Illustratively, inputting a customer's personal information and specific merchant information into a portable unit and wirelessly transmitting the customer's personal information and specific merchant information from said portable unit includes using at least one of a Universal Serial Bus (USB) protocol, FireWire protocol, PS/2 protocol, RS232 protocol, RS485 protocol, RS422 protocol, WiFi protocol, BlueTooth protocol, infrared interface, other Radio Frequency (RF) interface, and wired interface.

Illustratively, wirelessly transmitting the customer's personal information and specific merchant information from the portable unit to the host device comprise transmitting the customer's personal information and specific merchant information through a secure mesh-capable protocol or architecture.

Illustratively, transmitting the customer's personal information and specific merchant information from the host device to a transaction processor comprise transmitting the customer's personal information and specific merchant information from the host device to the transaction processor over a wide area network (WAN).

Illustratively, the method further includes transmitting the customer's personal information and specific merchant information received by transaction processor from the host device over a WAN to a third party processor for authorization and verification.

Illustratively, the method further includes transmitting authorization and verification from the third party processor to the host device.

Illustratively, the method further includes transmitting authorization and verification from the host device to the portable device.

Illustratively, the method further includes placing a paper receipt over one of a touch-screen and a digitizing signature pad, and the customer completing the financial transaction by providing the customer's approval signature on the paper receipt.

Illustratively, the method further includes transmitting the customer's approval signature from the portable unit to the host device and transmitting the customer's signature from the host device to the transaction processor.

Illustratively, the method further includes providing one of a touch-screen and a digitizing signature pad, and the customer completing the financial transaction by providing their approval signature to said one of a touch-screen and a digitizing pad which captures said approval signature in an electronic form.

Illustratively, the further includes transmitting the customer's approval signature from the portable unit to the host device and transmitting the customer's signature from the host device to the transaction processor.

Illustratively, the method further includes remotely programming the portable unit and host device.

Illustratively, the method further includes providing on at least one of the portable unit and the host device one of a Media Access Controller (MAC) and another unique identifier to permit the at least one of the portable unit and the host device to be disabled.

Illustratively, the method further includes at least one of encrypting and layering in order for the information to be securely transferred between at least one of the following pairs of devices: the portable unit and the host device; the host device and a local area network (LAN); and, the host device and a wide area network (WAN).

### BRIEF DESCRIPTION OF THE DRAWING

The invention may best be understood by referring to the following detailed description and accompanying drawing which illustrates the invention. The drawing illustrates a block-type system diagram of a basic network communication system employing mobile point-of-sale devices, a fixed-based point-of-sale device and a host device, all employing a secure mesh-capable protocol.

Referring now to the drawing, a mobile point-of-sale device system 100 operates using a secure mesh-capable protocol (e. g., ZigBee). The mobile point-of-sale device system 100 includes one or more mobile point-of-sale devices 101a and a secure mesh-capable host device 104. Only one mobile point-of-sale device 101a is shown, however, it is understood that any number of mobile point-of-sale devices 101a can be deployed in a mobile point-of-sale device system 100. Each mobile point-of-sale device 100a contains a device that can read the cardholder's identifying data from a card and a method to enter data such as the price of the goods or services to be purchased. One example would be a portable device containing a magnetic strip reader (to capture the cardholder's identifying data contained on the magnetic strip on the cardholder's credit or debit card) and a touch-screen to enter the price of the goods or services to be purchased by the cardholder. Each mobile point-of-sale device 100a may or may not also contain any combination of peripheral devices (e. g., barcode reader, radio frequency identification (hereinafter sometimes RFID) device, biometric sensor, printer, and so on).

In one simple illustration of the present invention, a merchant enters the cost of goods or services the cardholder is purchasing on a pressure-sensitive digitizing touch-screen. The cardholder “swipes” the cardholder's credit card through a mobile point-of-sale device 101a. The cardholder's identifying data from a magnetic strip on the back of the cardholder's card along with amount of goods or services the cardholder is purchasing is transmitted using a secure mesh-capable protocol to a secure mesh-capable host device 104. The mesh-capable host device 104 transmits the cardholder's identifying data along with cost of goods or services the cardholder is purchasing through a wide area network (WAN) such as the Internet to a transaction processor 105. The mesh-capable host device 104 may transmit or receive data to or from the transaction processor 105 either by a fixed method (e. g., land-line telephone or DSL/cable modem) or wirelessly (e. g., cellular or satellite telephony).

The transaction processor 105 temporarily stores the cardholder's identifying data along with cost of goods or services the cardholder is purchasing, and simultaneously transmits the cardholder's identifying data along with cost of goods or services the cardholder is purchasing to the financial institution or merchant services provider (e. g., Visa®, MasterCard®, American Express®) 108 associated with the cardholder's card through a third-party processing center (e. g., Verisign®, Authorize.net®) 106.

If the purchase is approved by the financial institution or merchant services provider 108, an authorization code is transmitted back to the transaction processor 105, where the authorization code is temporarily stored with the corresponding cardholder's identifying data and the cost of goods or services the cardholder is purchasing.

The transaction processor 105 transmits the authorization code to the mesh-capable host device 104, and the authorization code is retransmitted to the mobile point-of-sale device 101a associated with this financial transaction. After the authorization code is received by the mobile point-of-sale device 101a, the cardholder is prompted to complete the financial transaction by verifying the amount of the financial transaction, adding a tip if appropriate or desired, and providing the cardholder's approval signature on the pressure-sensitive digitizing touch-screen using a stylus pen.

The pressure-sensitive digitizing touch-screen converts the cardholder's approval signature into an electronic form and transmits it to the transaction processor 105 where it is “matched” with the corresponding cardholder's identifying data, the cost of goods or services purchased, and the authorization code. The electronic form cardholder's approval signature, the cardholder's identifying data, the cost of goods or services purchased, the authorization code and other data related to that specific cardholder's financial transaction that may have been obtained by the mobile point-of-sale device 101a (e. g., bar code data) are then stored by the transaction processor 105 for later retrieval or transmittal.

Since the mobile point-of-sale device system 100 is based upon a mesh-capable protocol, the transmission of data to and from a particular mobile point-of-sale device 101 or 101a can occur through any combination of numerous devices that are linked to the individual mobile point-of-sale device system 100. Again referring to the drawing, data may be transmitted from a mobile point-of-sale device 101 to a fixed-based point-of-sale device 103 and then to the mesh enabled host device 104. Another pathway for data transmission would be to and from a mobile point-of-sale device 101 though a signal repeater device 102 that relays the data to either a fixed-based point-of-sale device 103 and then to the mesh enabled host device 104, or directly from the signal repeater device 102 to the mesh-capable host device 104.

If desired by a particular user, such as a merchant with multiple locations, additional mesh-capable host devices 110 that are transmitting and receiving data from additional mobile point-of-sale devices and/or signal repeaters 109 can be connected through local area networks (hereinafter sometimes LANs) or WANs.

Although the invention has been described with reference to specific embodiments, and many features and advantages of the invention are apparent from the detailed specification, the foregoing description should not be construed in a limiting sense. Further, since numerous modifications and changes of the disclosed embodiments, as well as alternative embodiments of the invention will become apparent to persons skilled in the art, it is not desired to limit the invention to the exact construction and operation illustrated and described. It is therefore contemplated that such modifications can be made without departing from the spirit or scope of the present invention as defined, and accordingly all suitable modifications and equivalents that may be resorted to are included within the scope of the claimed invention.

What is claimed is:

1. A method for completing a financial transaction between a customer and a merchant of goods or services comprising:
inputting a customer's personal information and specific merchant information into a portable unit and wirelessly transmitting the customer's personal information and specific merchant information from said portable unit;
wirelessly receiving the customer's personal information and specific merchant information from the portable unit at a host device;
after acquiring the customer's personal information and specific merchant information from the portable unit, transmitting the customer's personal information and specific merchant information from the host device to a transaction processor for verification and authorization of the customer's personal information and specific merchant information; and
after verification and authorization of the customer's personal information and specific merchant information is received by the transaction processor, transmitting the verification and authorization from the transaction processor back to the portable device through the host device for completion of the financial transaction.

2. The method of claim 1, wherein inputting a customer's personal information and specific merchant information into a portable unit and wirelessly transmitting the customer's personal information and specific merchant information from said portable unit includes using at least one of a magnetic strip reader, a radio frequency identification (RFID) reader, a touch-screen, a digitizing signature pad, a barcode reader, and a biometric sensor for acquiring at least one of the customer's personal information and the specific merchant information.

3. The method of claim 1, wherein inputting a customer's personal information and specific merchant information into a portable unit and wirelessly transmitting the customer's personal information and specific merchant information from said portable unit includes using at least one of a Universal Serial Bus (USB) protocol, FireWire protocol, PS/2 protocol, RS232 protocol, RS485 protocol, RS422 protocol, WiFi protocol, BlueTooth protocol, infrared interface, other Radio Frequency (RF) interface, and wired interface.

4. The system of claim 1 wherein wirelessly transmitting the customer's personal information and specific merchant information from the portable unit to the host device comprise transmitting the customer's personal information and specific merchant information through a secure mesh-capable protocol or architecture.

5. The method of claim 4 wherein transmitting the customer's personal information and specific merchant information from the host device to a transaction processor comprise transmitting the customer's personal information and specific merchant information from the host device to the transaction processor over a wide area network (WAN).

6. The method of claim 5 further including transmitting the customer's personal information and specific merchant information received by transaction processor from the host device over a WAN to a third party processor for authorization and verification.

7. The method of claim 6 further including transmitting authorization and verification from the third party processor to the host device.

8. The method of claim 7 further including transmitting authorization and verification from the host device to the portable device.

9. The method of claim 8 further including placing a paper receipt over one of a touch-screen and a digitizing signature pad, and the customer completing the financial transaction by providing the customer's approval signature on the paper receipt.

10. The method of claim 9 further including transmitting the customer's approval signature from the portable unit to the host device and transmitting the customer's signature from the host device to the transaction processor.

11. The method of claim 8 further including providing one of a touch-screen and a digitizing signature pad, and the customer completing the financial transaction by providing their approval signature to said one of a touch-screen and a digitizing pad which captures said approval signature in an electronic form.

12. The method of claim 11 further including transmitting the customer's approval signature from the portable unit to the host device and transmitting the customer's signature from the host device to the transaction processor.

13. The method of claim 2 further including remotely programming the portable unit and host device.

14. The method of claim 13 further including providing on at least one of the portable unit and the host device one of a Media Access Controller (MAC) and another unique identifier to permit the at least one of the portable unit and the host device to be disabled.

15. The method of claim 3 further including at least one of encrypting and layering in order for the information to be securely transferred between at least one of the following pairs of devices: the portable unit and the host device; the host device and a local area network (LAN); and, the host device and a wide area network (WAN).
